(19) United States
(12) Patent Application Publication
(10) Pub. No.: US 2004/0075963 A1
(43) Pub. Date: Apr. 22, 2004

(54) Solenoid energy control method and a multi-stage over-current protector

(75) Inventors: Zhongdu Liu, Fremont, CA (US); Zhe Wu, San Jose, CA (US); Lloyd Ebisu, Cupertino, CA (US)

Correspondence Address: Bo-In Lin, 13445 Mandoli Drive, Los Altos Hills, CA, 94022, US

(73) Assignee: SOLIDONE USA Corp.

(21) Appl. No.: 10/273,757

(22) Filed: Oct. 18, 2002

(51) Int. Cl. H02H 3/00

(52) U.S. Cl. 361/42

(57) ABSTRACT

This is an innovative Over-Current Protection device that uses a unique method of controlling the energy to a compact tripping solenoid of a mechanical circuit breaker mechanism to cut off power to an electric circuit whenever the load current exceeds a specified level. Unlike previous Over-Current Protection devices, this device also maintains independent levels or stages of over-current protection and is able to distinguish between stages via independent current detection circuits that define the operational characteristics of each over-current stage. The device includes a current sensing transformer, independent current-threshold detectors, time delay circuits and a random phase, energy-accumulating circuit which generates a controlled trigger-pulse to trip the compact tripping solenoid of the mechanical circuit breaker mechanism. This device is also designed to connect directly onto, and operate in conjunction with, an existing GFCI (Ground Fault Circuit Interrupter) module. The method of using an energy control electronic circuit to deliver precisely controlled energy to a compact tripping solenoid may also be implemented for connecting to other kinds of mechanical-electric relays, circuit breakers and power contactors.

### BACKGROUND OF THE INVENTION

1. Field of the Invention

This invention relates generally to a method and its circuit implementations to trip a solenoid for over-current protection or circuit fault protections. More particularly, this invention relates to a unique method of tripping a solenoid during an over-current condition operating in conjunction with a multi-stage over-current protection function that enhances its ability to protect the electric circuit by driving the tripping solenoid for the purpose of over current tripping and over-surge current tripping capability.

2. Description of the Prior Art

Conventional techniques of design and manufacture of over current trip or circuit fault protection devices are still faced with the limitations of inconsistent operation, complicated construction, and an adjustment procedure to set the trip current during the manufacturing process. The resulting device therefore requires a time-consuming process to manufacture thereby increasing its cost. Furthermore, the ability of the conventional device to detect over-surge currents is dependent on its mechanical construction rather than being specifically adjustable. This in turn means that the device will respond inconsistently to different over-surge current values.

For over-current protection, according to a White Paper published by E-T-A Circuit Breakers there are several kinds of circuit breakers, such as thermal, thermal-magnetic, magnetic with hydraulic delay, and magnetic types with the operation characteristics of circuit tripping shown in E-T-A Internet website. Each technology has a different trip profile in relation to time and current and each has distinct mechanical characteristics. However, for each specific product line, flexibility is allowed for adjusting only the primary over-current trip mechanism usually by applying a hardware-set screw for fine-tuning threshold voltage adjustments. All other parameters are not user-adjustable due to the construction of the breaker and the material or method used to construct the breaker.

Furthermore, a conventional circuit breaker is designed to trip at a pre-specified current level. While this trip current is somewhat selectable, the trip current is frequently the only specifiable parameter for the conventional circuit breaker. However, during initial turn-on of heavy-duty inductive loads a large surge current is typically required at the load. The conventional circuit breaker is able to somewhat accommodate this surge current, but this over-surge current value is not accurately specifiable since this function falls out of the construction and choice of materials used for the manufacture of the breaker. A typical method of adjusting the common circuit breaker is to turn a setscrew to achieve the specific trip current for the breaker. But this trip current adjustment is a manufacture site setting requiring costly technician time and equipment. The over-surge current trip point is then empirically measured to determine its current-tripping profile.

In order to allow more flexibility for over-current protections, Siemens Electronics disclosed an electronic trip unit that utilizes a microprocessor to execute the myriad of numeric and logic functions programmed in the unit. A user is allowed to enter numeric values to the microprocessor. The microprocessor then stores and applies the values entered for carrying out over current protection. However, since these kinds of electronic trip units are only suitable for high-cost industrial applications, broad applications of the electronic trip units would not be practical.

In addition to the conventional circuit breakers, there are other kinds of circuit interrupting devices such as the GFCI (ground fault circuit interrupter). GFCI control and detection circuit triggers an SCR to drive a solenoid for tripping a mechanical circuit breaker to open the electric circuit and stop the flow of electricity. In its basic form the GFCI device could be viewed simply as a “smart” circuit breaker to open the electric circuit when a ground-fault leakage current is detected. One disadvantage of the method that a GFCI device uses to drive the compact tripping solenoid is the permanent damage that can occur to the compact solenoid if the mechanical circuit breaker fails to open upon activation, i.e. when the mechanical circuit breaker is corroded. The compact solenoid will burn out because a) the solenoid is designed to conduct current only for a short duration until the mechanical circuit breaker opens, and b) GFCI devices typically fire on every half cycle of the AC waveform. If the mechanical circuit breaker remains closed as the compact solenoid is attempting to trip it open the current through the compact solenoid can result in permanent damage to the solenoid thereby rendering the GFCI inoperable and un-repairable.

Conventional devices that combine GFCI functions with that of a circuit breaker require a mechanical linkage between the tripping solenoid of the GFCI and the mechanical circuit breaker of the Circuit Breaker as that disclosed in U.S. Pat. No. 5,745,322 by Duffy et al. This results in a complicated and cumbersome construction in the final device. Fuhr et al. disclose in U.S. Pat. No. 6,259,340 a circuit breaker with dual test button mechanism for use in a circuit breaker. A single switch is used for testing both the arc fault circuit interruption and ground fault circuit interruption built as a combined unit with similar complicated mechanical circuit breaker. Due to their mechanical structures, these combined units are usually built as heavy and bulky devices and manufactured with higher production costs because the more time consuming and complicated manufacturing processes are required.

For the above reasons, a need still exists in the art of designing and manufacturing a current interrupting device for over-current protection or circuit fault protection to resolve above mentioned difficulties and limitations.

### SUMMARY OF THE PRESENT INVENTION

It is therefore an object of the present invention to provide a novel and improved multiple-fault circuit interrupter (MFCI) formed with simple circuit configuration that can be implemented as an integrated circuit (IC) chip and ready to adapt to a compact solenoid trip mechanism to function as an electronic circuit breaker. This over-current protection chip has a low production cost and compact size benefited from its simple circuit configuration while providing precise control of tripping energy and instant response to the circuit fault conditions that occur at random AC initial phase angle. Therefore, the above-mentioned limitations and difficulties as now faced by the conventional technologies are resolved.

It is therefore an object of the present invention to provide a novel and improved Multiple Fault Over-Current Circuit Interrupter (MFCI) formed with a simple circuit configuration that can be implemented as small adapting electronic trip module or as an integrated circuit (IC) chip. Furthermore, this MFCI circuit can be easily adapted to GFCI modules to provide an independent over-current protection function that operates in parallel without affecting the original circuits and the ground fault protection functions of the GFCI. Furthermore, damages to the compact tripping solenoid can be prevented when the MFCI circuit is implemented with the GFCI.

The MFCI is intended for use with a compact tripping solenoid and an associated mechanical circuit breaker. The latch carries the line current to the load and is tripped by a compact Tripping Solenoid, which then causes the line current to stop when the MFCI detects an over-current condition. The current protection functions are automatically built in as that set into the MFCI design and there are no screws or terminals to adjust during the manufacturing process. Furthermore, flexibilities are allowed for the users to make necessary over current protection adjustments for both the initial surge and normal operation conditions depending on intended applications. Therefore, the above-mentioned limitations and difficulties as now faced by the conventional technologies are resolved.

Specifically, the MFCI protects an electric circuit from serious damage by shutting off the electric AC power if an over-current condition arises downstream in the electric circuit. The MFCI provides dynamically expandable ranges of over current protections and the expandable range can be implemented as multiple stages or several levels of Over-Current Protection to the AC Load by electronically incorporating the protection functions into the MFCI circuit design. For a most common application the expanded range of protections can be implemented as a “multi-stage” over current protection device. The first stage is generally referred to as the Over-Surge Current Protection stage—this stage monitors the initial surge current generated by the load when the power is first applied. The second stage and if necessary subsequent stages of Over-Current Protection control varying levels of current and can be selected to fit a wide variety of load-current profiles.

The Over-Surge Current Protection circuit monitors the value of the initial turn on current to the electric circuit. During this initial turn on period the subsequent Over-Current Protection circuits are disabled. If the initial current exceeds a preset value the MFCI generates a trigger to the external solenoid that cuts off power to the electric circuit. Furthermore, a built-in timer disables the Over-Surge Protection circuit after a set time period and automatically enables the subsequent Over-Current Protection circuits for steady-state operation.

The Over-Current Protection circuits monitor the value of the steady-state current to the electric circuit. When this steady-state current exceeds a preset value the MFCI generates a trigger signal to the external tripping solenoid to cut off power to the electric circuit. Each stage has an associated time duration and is individually adjusted. Thus, the electric current trip values for both the over-current protection circuit and the over-surge current protection circuit are independently selectable. The trip current for the Over-Current stage is selectable via a component value and needs no adjustments once the component is selected. The trip current for the Over-Surge Current stage is selectable via another component value and needs no adjustments once the component is selected. The over-surge current protection takes effect when the MFCI is first turned on. It is especially useful for heavy-duty inductive loads in which high surge currents are generated during the first few seconds of turn on. The circuit that manages the Over-Surge Current Protection function controls both the duration of protection and the magnitude of the over-surge current. As with the Over-Current stage, the trip values for this stage are also selectable via component values and needs no adjustments.

Therefore, this invention provides a much simpler means of manufacturing an over-current protection device when compared to the mechanical ones. Unlike most of the conventional over-current circuit breakers, the MFCI of this invention does not require individual in-circuit adjustments to set the over-current trip operation thus significantly improving the manufacturing processes of the product because all components are fixed for each current-tripping setting. Timesavings for manufacturing the products are achieved for there is no adjustment required.

Another object of this invention is the ability to easily attach to an existing GFCI module without modifications. The MFCI supplements the operation of the GFCI by providing Over-Current protection currently lacking in GFCI modules. In contrast to the conventional combined units of GFCI and over-current protection devices, instead of cumbersome and complicated latching mechanism, the MFCI requires only two wires to connect to the MFCI into an existing GFCI circuit. Since the MFCI shares the use of a compact tripping solenoid and the mechanical circuit breaker of the GFCI, the need for an additional mechanical linkage is unnecessary.

Briefly, this invention discloses a method for protecting an electric device from a circuit fault by controlling a circuit breaker current iBS in a current-conducting duration tBs to conduct part of the circuit breaker current through a compact tripping solenoid triggered by the circuit fault. This provides a controlled amount of energy to said compact tripping solenoid which trips the mechanical circuit breaker and interrupts the current through the electric device. This invention further discloses a fault protection apparatus for protecting an electric device from a circuit fault. The fault protection circuit further comprises a trigger-pulse terminal connected to a solenoid tripping control terminal of the compact tripping solenoid for responding to the circuit fault to provide a trigger-pulse with a controlled pulse with a pulse width t_{w} for conducting a corresponding circuit breaker current i_{BS} in a time duration t_{BS} corresponding to the pulse width t_{w} through a compact tripping solenoid for providing controlled amount of energy to the compact tripping solenoid to interrupt a current conducting through the electric device

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1 shows a circuit block diagram for illustrating a multi-fault current interrupter (MFCI) of this invention connected to a ground fault circuit interrupter (GFCI) as a hybrid over-current and ground fault protection circuit;

FIG. 2 is a schematic diagram showing a specific implementation of the MFCI of this invention as a Solidone product SM100DE connected to a GFCI to provide functions of ground fault and multi-stage over current protections;

FIGS. 3A to 3D are circuit block diagrams shown together with waveform analyses for illustrating methods of tripping energy control on the compact tripping solenoid coil with the tripping pulse triggered at random initial-phase angles when detecting an over-current condition;

FIGS. 4A to 6F are waveform analyses for illustrating the ON-State working phase angle θ that drives the current to the compact solenoid coil in response to a trigger pulse. tw, width represented by θtw of the triggering pulse imposed on dual half waves (DHW) generated at six typical initial phase angles φ when the over current tripping occurs at random initial phase angles; and

FIGS. 7A shown together with 7B are circuit schematic diagrams showing another embodiment of the initial tripping current dynamic expanding (ITDE) circuit of this invention for providing a multiple-stage over-current protection device.

FIG. 8A shows the operational characteristic curve of the initial tripping dynamic expanding (ITDE) circuit of this invention and 8B, 8C are two embodiments of the initial tripping dynamic expanding (ITDE); and

FIGS. 9A and 9E are operational characteristic curves of the initial tripping dynamic expanding (ITDE) circuit of this invention and FIGS. 10B, 10C and 10E and 10F are two alternate embodiments of the initial tripping dynamic expanding (ITDE).

### DETAILED DESCRIPTION OF THE INVENTION

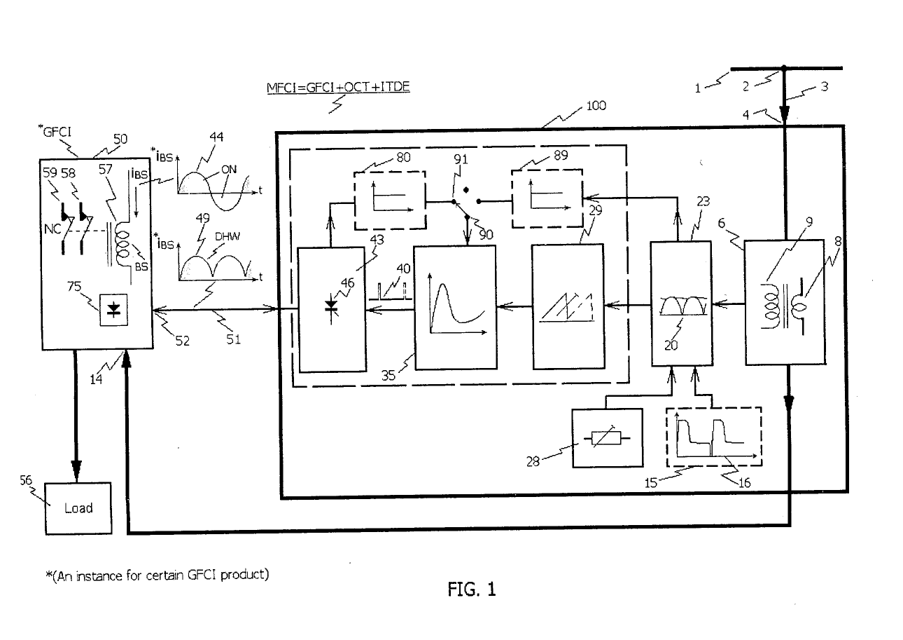

Referring to FIG. 1 for a functional block diagram of a multiple fault circuit interrupter (MFCI) of this invention. In this preferred embodiment, it illustrates the typical connection between the MFCI 100, the compact Tripping Solenoid 57 and the mechanical circuit breaker mechanism 58 and 59. The ON time for the SCR 46 in the MFCI is represented by the AC waveform 49 at the output 51 of the MFCI. In this embodiment, the current passes through the compact solenoid Tripping Solenoid 57 is activated each half-cycle of the AC waveform. The current through the Tripping Solenoid follows a Dual Half Wave (DHW) signal waveform 49 by full wave rectified. As that shown in FIG. 1, the MFCI 100 is intended for use in conjunction with a compact Tripping Solenoid 57 and mechanical circuit breaker mechanism 58/59. The compact Tripping Solenoid 57 causes the Breaker Contacts 58/59 to open when Current, iBS, thru the compact Tripping Solenoid 57 is activated. The Breaker Contacts 58/59 has two contact points to the AC line voltage. One is for the Phase Line and the other for the Neutral line.

During its idle or inactive state the MFCI 100 monitors the voltage at two points—the current in the Electric Circuit 1/2/3/4 and the Voltage 51 from the compact Tripping Solenoid 57. The Voltage 51 from the compact Tripping Solenoid 57 is routed to the DC Voltage Reference 80 that generates a specified voltage level that is compared to the voltage generated by the collection of circuits connected to the output of the Secondary Coil 9 of the Current Transformer 6. In the idle or inactive state the Voltage 91 out of the Voltage Reference 80 is always greater than the voltage from the Integrator 29. In this case the Trigger Pulse Generator 35, which compares the voltages out of the Voltage Reference 80 and the Integrator 29, will not generate a Trigger Pulse 40 to the output SCR 46.

In this embodiment the Voltage Reference 80 is connected to the SCR 46 because the Trigger Pulse Generator 35 does not have an internal voltage reference source. However, the design is flexible enough so that the Voltage Reference 80 can be provided from the Rectifier Bridge 23—instead of the SCR—or removed completely if the Trigger Pulse Generator 35 contains a built-in voltage reference source. Also, the SCR 46 can be replaced with any Thyristor or a transistor to achieve very similar results in activating the compact Tripping Solenoid 57.

If the voltage output of the Integrator 29 is greater than the voltage out of the Voltage Reference 80, the Trigger Pulse Generator 35 will generate Trigger Pulses 40 to the SCR 46, which will then activate the compact Tripping Solenoid 57 and trip the Mechanical Circuit Breaker Mechanism 58/59. The Trigger Pulses 40 are synchronized to the output of the Integrator 29 as we see in later sections.

When Current 1/2/3/4 flows through the Primary Coil 8 of the Current Transformer 6 in the MFCI 100 the AC voltage across the Secondary Coil 9 increases. The voltage across the Secondary Coil 9 is rectified by a Rectifier Bridge 23 to provide a drive signal input to the MFCI 100, the MFCI 100 also generates the Voltage Levels 20 used for current detection. If little or no current is flowing through the Electric Circuit 1/2/3/4 and the Primary Coil 8 of the Current Transformer 6 there is no voltage present at the output of the Secondary Coil 9. Under these conditions the MFCI 100 consumes no power.

The output of the Rectifier Bridge 23 goes to three sections. The first section is the Integrator 29. The Trigger Pulse Generator 35 compares the output of the Integrator 29 to the Voltage Reference 80. When the voltage out of the Integrator 29 is greater than the Voltage Reference 80 the Trigger Pulse Generator 35 generates the Trigger Pulses 40 to the SCR 46. This, in turn, enables current iBS to flow through the compact solenoid Tripping Solenoid 57 and causes the Breaker Contacts 58/59 to open.

The second section is the Steady-State Reference 28. This section determines the trip-current level for steady-state current flowing through the Electric Circuit 1/2/3/4 and the Primary Coil 8 of the Current Transformer 6. When the current flowing through the Primary Coil 8 is large enough the AC voltage across the Secondary Coil 9 increases. The AC voltage passes thru the Rectifier Bridge 23 that converts the AC voltage to a full wave rectified signal sent to the Steady-State Reference 28. The Steady-State Reference 28 attenuates the voltage out of the Rectifier Bridge 23 such that a particular level of steady-state current must flow through the Primary Coil 8 so that the voltage out of the Integrator 29 is greater than the output of the Voltage Reference 80. The Trigger Pulse Generator 35 then generates the Trigger Pulses 40. The Steady-State Reference 28 is the final stage of the multi-stage current detection circuits and operates on the steady-state current flowing through the Primary Coil 8 of the Current Transformer 6. The setting for the Steady-State Reference 28 is adjustable and is selected at the factory or by the customer.

The third section is the Dynamic Expander 15. The Dynamic Expander 15 is the first stage of the multi-stage current detection circuits. The Dynamic Expander 15 works in conjunction with the Steady-State Reference 28 to further attenuate the voltage output of the Rectifier Bridge 23. The amount of reduction in the voltage is adjustable within the Dynamic Expander 15 and is set at the factory or by the customer. By further reducing the output voltage of the Rectifier Bridge 23 more current needs to flow through the Primary Coil 9 of the Current Transformer 6 in order to generate the voltage out of the Integrator 29 necessary to compare with Voltage Reference 80 and generate the Trigger Pulses 40 out of the Trigger Pulse Generator 35.

Furthermore, a time delay circuit in the Dynamic Expander 15 is activated the moment a detectable level of Current 1/2/3/4 flows through the Primary Coil 8 of the Current Transformer 6. This time delay circuit in the Dynamic Expander 15 determines the length of time the Dynamic Expander 15 is active. This time is adjustable at the factory or by the customer. After the time delay circuit in the Dynamic Expander 15 expires, the voltage out of the Rectifier Bridge 23 reverts to a level determined by the Steady-State Reference 28 thereby permitting the steady-state current level to generate the voltage out of the Rectifier Bridge 23 necessary to generate the Trigger Pulses 40.

The Dynamic Expander 15 provides a means to accommodate the initial surge current that usually occurs when the Current 1/2/3/4 is initially applied to a load 56. The waveforms 16 depict the current-profile of the Dynamic Expander 15. The Dynamic Expander 15 monitors the initial Current 1/2/3/4 and its duration. If the current flowing thru the Primary Coil 8 is greater than the limit set in the Dynamic Expander 15, the voltage level out of the Rectifier Bridge 23 will be enough to cause the output of the Integrator 29 to be greater than that of the Voltage Reference 80. This, in turn, will cause the Trigger Pulse Generator 35 to send the Trigger Pulses 40 to the SCR 46 and activate the compact Tripping Solenoid 57. Although in this embodiment only one Dynamic Expander 15 stage is shown, additional stages may be added to provide a variety of current limits. The number of additional stages is limited by the amount of current generated by the Secondary Coil 9.

The waveform 44 illustrates the angular phase along a time axis to show when in the AC cycle the compact Tripping Solenoid 57 current, iBS, is ON. The waveform 49 illustrates the equivalent DHW_cycles for iBS.

Therefore, this invention discloses a method for protecting an electric device from a circuit fault by controlling the current i_{BS} and its duration of current-conducting period t_{BS} for driving the compact tripping solenoid of a ground fault circuit interrupter (GFCI) triggered by the circuit fault and providing a controlled amount of energy to the compact tripping solenoid to trip the GFCI and interrupt current flowing through the electric device.

This invention thus resolves the difficulty often encountered by a person of ordinary skill in the art that when merging the two functions—GFCI and Over-Current Protection—a complicated means of interconnecting and construction is required. Due to the means in which the Circuit breaker stops the current to the load, a mechanical linkage as well as an electronic linkage between the GFCI and circuit breaker sections of the combined device is required. This makes for a less reliable interconnection than a pure electronic one and further increases the complexity during the manufacture of the device; leading to increased inconsistencies in operation. In contrast, the adapting module MFCI as shown can be conveniently adapted to the GFCI with only two connecting terminals while working in parallel with GFCI without interfering or degrading of the operation of the GFCI. This invention further provides a simple over-current protection circuit using only simple and widely available circuits to function in corporation and in parallel with the GFCI.

This invention further discloses a fault protection apparatus for protecting an electric device from a circuit fault. The fault protection circuit comprises a ground terminal connected to a common ground terminal with a ground fault circuit interrupter (GFCI). The fault protection circuit further comprises a trigger-pulse terminal connected to a compact solenoid tripping control terminal of the GFCI for responding to the circuit fault to provide a trigger-pulse with a controlled pulse width tw for conducting a corresponding solenoid current i_{BS} in a time duration corresponding to the pulse width tw through a solenoid of the GFCI for providing controlled amount of energy to the compact solenoid to trip the GFCI and interrupt a current conducting through the electric device.

Referring to FIG. 1 again for a more specific description for the multi-fault circuit interrupter (MFCI) 100. The MFCI 100 includes a current transformer sensor 6 for sensing and generating a current in response to a load input current. The current transfer sensor 6 further includes a transformer for transferring an input source current conducted from the current source 1 as an AC input current to the MFCI 100 for inputting to an AC/DC converter 23 for generating a DC voltage signal and a reference voltage. A special advantage of the present invention is the option as further described below to make use of the AC input current to provide this reference voltage thus eliminates the need for an external power supply. The DC voltage signal passes thru a saw-tooth waveform circuit 29 to generate a saw tooth output voltage pulses for inputting to a relaxation oscillator 35. The relaxation oscillator 35 can be implemented as a UJT (Uni-Junction Transistor) or PUT (Programmable Uni-Junction transistor) or a PNP-NPN Bi-polar transistor pair and makes use of a reference voltage of provided from a reference voltage connection selector 90. The reference voltage connection selector 90 is provided with different options for connecting to an input voltage reference voltage 89 which direct draw a voltage from the AC/DC converter 23. The reference voltage connector is also provided with an option for externally connecting to the SCR1 43 reference voltage circuit 80 for drawing a reference voltage from the SCR1. As the saw tooth shaped voltage processed by the relaxation oscillator 29, under the circumstance when an over-current occurs, a series of pulses are generated. The first pulse is imposed onto the SCR1 in the GFCI to produce a tripping energy to trip the compact solenoid and cut off the input current. In actuality, the second pulse is shown as a dotted line pulse because the second pulse would not be generated when the current is tripped and the second saw tooth shaped current also shown as dotted line saw tooth would not be generated.

The MFCI 100 further includes a tripping threshold preset circuit 28 connected to a multi-stage threshold-voltage dynamic expanding circuit 15. This multi-stage threshold-voltage dynamic expanding circuit 15 allows the threshold-voltage for activating a circuit tripping to have stage-wise adjustments with each stage maintains a predefined trip-voltage threshold wherein each stage has a predetermined duration of time. One specific implementation is to apply the multi-stage threshold-voltage adjustment circuit as an initial trip-voltage dynamic expanding (ITDE) circuit to expand the trip-voltage threshold during an initial stage when the circuit is turned on and a larger amount of surge current passes through the MFCI thus produces a higher voltage. This ITDE circuit 15 is able accommodate an initial current surge when the circuit is turned on for a predefined duration to prevent unnecessary circuit tripping due to initial current surges.

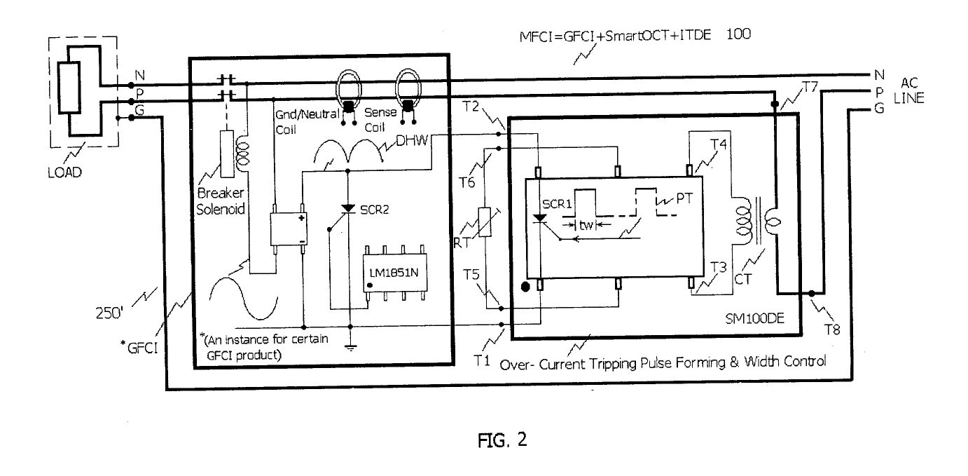

According to FIG. 1, this invention discloses an adapting module, e.g., MFCI 100, for adapting to a current interrupter, e.g., GFCI 50, and transmitting the signal through adapting terminal terminals, e.g., terminals 52 and a common ground shown as T2 and T1 in FIG. 2 below, for activating an over-current protection. The adapting module 100 includes a multi-stage threshold-current adjustment circuit, e.g., a surge expanding circuit 15, for expanding a threshold voltage in detecting the above-threshold voltage for providing a two-stage over current protection. This invention can also support multi-stages for additional over current threshold voltages. In a preferred embodiment, the adapting module 100 further includes a current transformer 6 for transforming a load current to a corresponding voltage for detecting an above-threshold voltage to generate a current-interruption voltage signal for inputting to the circuit interrupter through the set of adapting terminals 52 and the common ground shown as T2 and T1 in FIG. 2. In a preferred embodiment, the MFCI 100 further includes a rectifier 23 for rectifying the corresponding voltage generated by the current transformer to a DC voltage. In a preferred embodiment, the MFCI 100 further includes a pulse generator, e.g., the saw-tooth waveform circuit 29 and the relaxation oscillator 35, for generating a triggering voltage pulse in detecting and responding to the above-threshold voltage. In a preferred embodiment, the MFCI 100 further includes a threshold detecting circuit for detecting the above-threshold voltage. In a preferred embodiment, the MFCI 100 further includes a SCR, e.g., SCR1 43, for inputting the pulse to through the pair of current interruption terminals to the current interrupter. In a preferred embodiment, the pulse generator further includes a pulse-width control means for controlling a pulse width of the triggering voltage pulse.

FIG.2 is a functional block diagram for showing the integration of a MFCI adapting module with a GFCI 250′. The GFCI as shown is just an example for illustrating the GFCI may be many kinds of GFCIs, and may be different from or the same as the GFCI as that shown in FIG. 2. In the preferred embodiment as shown, the over current tripping circuit 100 is implemented as a SM100DE module produced by Solidone Corporation to perform the functions of over current tripping pulse formation with width control when the load on the main power line exceeds a present over current level. The over current protection module as shown is implemented with a method to control and limit the compact solenoid tripping energy by controlling the pulse width of the trigger width tw. By controlling the pulse width tw, a corresponding solenoid current iBS is activated to pass through the solenoid for time duration of tBS to provide controlled amount of energy to activate the compact solenoid and trip the circuit for interrupting the current.

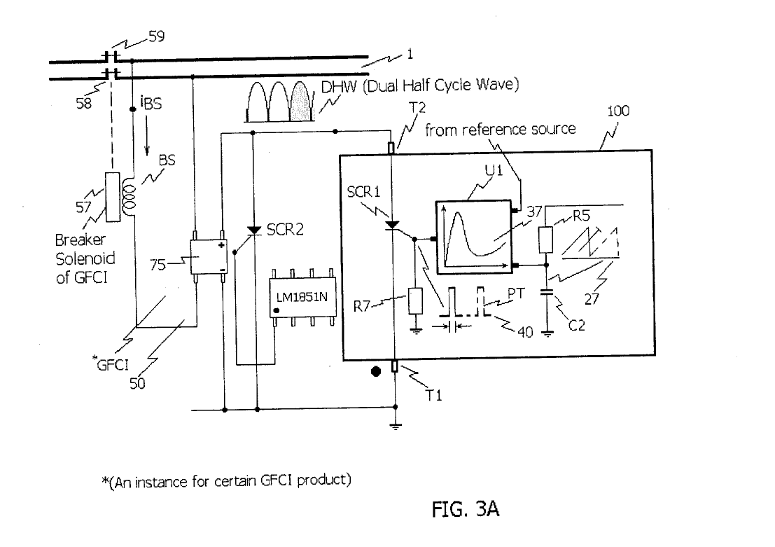

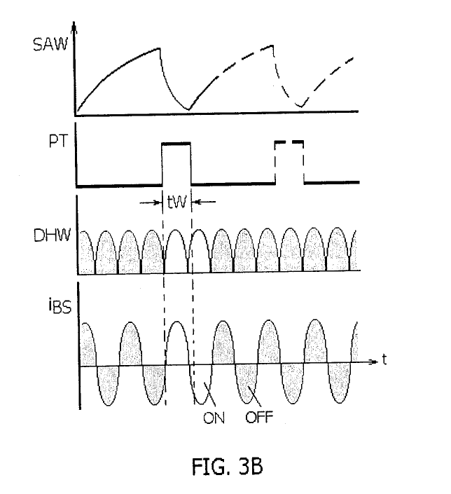

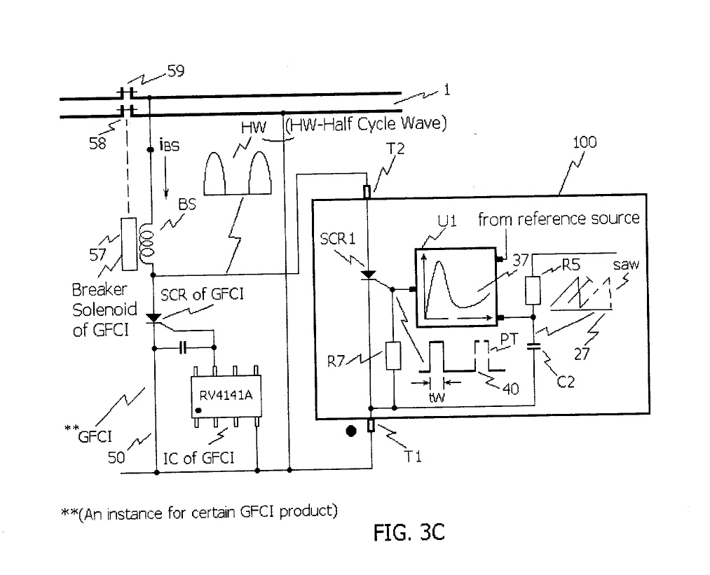

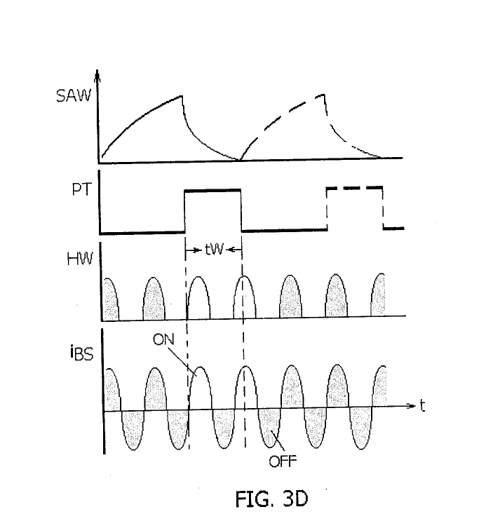

According FIG. 2 shows a trigger pulse is coupled through the gate of SCR1 to the tripping solenoid of the GFCI. The details of the methods used for energy control are further illustrated in FIGS. 3 to FIG. 6 below. The integrated MFCI circuit 100, e.g., SM100DE, with the GFCI 250′ as shown thus provides effective and low cost protection for the electric device taking advantage of the GFCI circuit tripping features by integrating a simple, compact and yet precisely controllable MFCI circuit 100 as disclosed in this invention. The disadvantages and difficulties of the conventional circuits breaker as that discussed above are resolved by this multi-stages precisely controlled and adjustable over-current protection device disclosed in this invention. Effective protections of devices from over-current damages with conveniently preset surge-current protection are therefore provided.

The functional block diagram as that presented in FIG. 2 is only presented to illustrate on specific embodiment. Actually, the typical connection of the multi-fault current interrupter (MFCI) of this invention may be implemented to drive the Tripping Solenoid of the mechanical circuit breaker mechanism for one of many traditional circuit interrupters, such as a circuit breaker, a relay, or a power contactor. The illustrations and descriptions as disclosed in FIG. 2 is not to be interpreted as limiting. Various alternations and modifications to connect the MFCI of this invention to different circuit interrupters, such as circuit breakers, relays and power contactors with mechanical latching-trip mechanisms, will no doubt become apparent to those skilled in the art after reading the above disclosure.

FIGS. 3A and 3B illustrates a waveform analysis for tripping energy control to the compact tripping solenoid of a GFCI during the activation of a random phase tripping. The waveform illustrates the current passes through the Tripping Solenoid (Breaker Solenoid) in a Full Wave Rectified dual half-wave (DHW) configuration when the MFCI is connected to a GFCI device. In this embodiment, the GFCI uses the LM1851 GFCI IC and a full wave rectifier that causes a dual half-wave (DHW) signal to drive the compact Tripping Solenoid. The waveforms depict the ON and OFF times of the SCR in the MFCI. The pulse width tW of the trigger pulse generated by the MFCI is selected such that the SCR is ON for a minimum of one half-cycle and a maximum of 2½ half-cycles. Unlike the GFCI, the MFCI does not rely on the opening of the Mechanical Latch Mechanism to stop it from sending subsequent Triggering Pulses to the SCR. The MFCI waits a predetermined pulse width and period before sending another Triggering Pulse to the SCR providing that the over-current condition still exists. This pulse width and period is selectable and pre-set in MFCI, it does not depends on the AC cycle, nor does it depend on any electrical-mechanical time delay or mechanical closed-loop response time delay as does the traditional GFCI design.

This invention thus discloses a method and circuit designs based on a functional principle entirely different from the conventional techniques includes the techniques implemented in the traditional GFCI design. Traditional GFCI design is implemented with carefully designed mechanical circuit breaker with accurate duration of delay of mechanical response before the latch is open for turning off the current thus controls the amount of energy pass through the compact tripping solenoid. The GFCI design take into account that there is a certain limited time between the activation of the compact Tripping Solenoid to the opening of the mechanical circuit breaker to stop the ground-fault current. However, if this assumption as applied by the GFCI design is not true under the circumstances that the time period is too long, e.g., the latch opening is delayed due to the corroded contacts in the mechanical circuit breaker mechanism, or slow trip activation of the compact Tripping Solenoid due to mechanical fatigues, damages may occur to the compact tripping solenoid. Under the condition that there is a slow response of the mechanical circuit breaker, the GFCI IC will continue to activate the compact Tripping Solenoid, which can result in permanent damage to the compact Tripping Solenoid.

In contrast, the energy control carried out by the MFCI of this invention does not depend on the opening of the mechanical circuit breaker to cut off the current and supply of energy to the compact tripping solenoid. As that shown in FIGS. 3A and 3B above, the MFCI, on the other hand, generates its own timing control, which is designed to prevent overdriving of the compact Tripping Solenoid. After generating the first Trigger Pulse, the MFCI will wait for a certain period of time before checking if another Trigger Pulse is needed. If the over-current condition still exists, a second Trigger Pulse is generated, otherwise the MFCI will return to its idle state. Therefore, the MFCI with its Energy Control method of triggering utilize a more compact Tripping Solenoid structure and will activate the compact Tripping Solenoid with better stability and consistency. As will be further explained below that the trigger pulse can be generated at any random initial phase angle. However, as noted in a conventional circuit breaker, the LM1851 does not have such flexibilities and must activate the compact Tripping Solenoid at each half-cycle until the fault condition is removed.

Referring to FIG. 3A again, the MFCI 100 is connected to a GFCI device utilizing a LM1851N IC. The connection between the MFCI 100 and the GFCI device is accomplished through two wires connected across SCR2. In this exemplary embodiment, the LM1851N drives the compact Tripping Solenoid 57 with SCR2 thru a Bridge 75 when a leakage-fault is detected. This results in a Full Wave Rectified (DHW) signal driving the compact Tripping Solenoid 57 when activated.

The waveforms as that shown in FIG. 3B illustrate the tripping action of the MFCI 100 when an over-current condition exists. Because the MFCI 100 is connected directly across SCR2 it, too, uses a signal DHW to drive the compact Tripping Solenoid 57. The top waveform represents the output of the Integrator 29 from FIG. 1A. The peaks of the saw-tooth waveform represent the points at which the output of the Integrator 29 is greater than the Voltage Reference 80. The Trigger Pulse Generator 35 then generates the Trigger Pulses 40 illustrated in the waveform labeled PT. Note that the Pulse Width, tW, is selected to span more than one half-cycle but less than 2½ half-cycles. This is purposely selected to insure the ON time of SCR1 in the MFCI 100 activates the compact Tripping Solenoid 57. The second waveform labeled DHW illustrates the relationship-DHW ip between the Trigger Pulses PT and. The DHW cycles indicate an active compact Tripping Solenoid 57. The following waveform labeled iBS illustrates the relationship between the Trigger Pulses PT and iBS, the current through the compact Tripping Solenoid 57. A second Triggering Pulse PT is generated (shown in dashed lines) if the first pulse did not result in opening the Breaker Contacts 58/59. Note that while for this particular embodiment a specific limit on the pulse width tW and period of the Triggering Pulse PT are specified, in actuality, the pulse width tW and the period of the Triggering Pulse PT can be set to any value.

FIGS. 3C and 3D illustrate another waveform analysis for tripping energy control to the compact tripping solenoid during an random phase activation of the compact tripping solenoid. FIG. 3D illustrates the current passes through the compact Tripping Solenoid (Breaker Solenoid) in a Half Wave rectified (HW configuration. In this exemplary embodiment shown in FIG. 3C, the GFCI HW uses the RV4141 GFCI IC. The absence of the rectifier results in the waveform condition. The waveforms depict the ON and OFF times of the SCR in the MFCI. The pulse width tW of the trigger pulse generated by the MFCI is selected such that the SCR1 is ON for a minimum of one half-cycle period and a maximum of 2½ half-cycle periods. Unlike the trip mechanism of the GFCI, the MFCI does not rely on the opening of the mechanical circuit breaker mechanism to prevent it from sending subsequent Trigger Pulses to the SCR. The MFCI waits a predetermined period before sending another Triggering Pulse to the SCR providing the over-current event still exists. This period is selectable and not dependent on the AC cycle. The trigger pulse can occur at any random phase angle with respect to the AC waveform. The GFCI RV4141 as shown in FIG. 3C activates the compact Tripping Solenoid at each alternating half wave cycles until the fault condition is removed.

Again, as shown in FIG. 3C, the MFCI 100 is connected to a GFCI device utilizing a RV4141A IC through two wires connected across the SCR of GFCI. The GFCI RV4141A drives the compact Tripping Solenoid 57 with the SCR of GFCI when it detects a leakage fault. Because a bridge is not used in this configuration this results in a Half Wave rectified (HW) signal driving the compact Tripping Solenoid 57. The waveforms to the right of the MFCI 100 as that illustrated in FIG. 3D, the tripping action of the MFCI 100 is activated when an over-current condition is detected. Because the MFCI 100 is connected directly across “SCR of GFCI” it, too, uses a half-wave (HW) signal to drive the compact Tripping Solenoid 57.

In FIG. 3D, the top waveform represents the output of the Integrator 29 from FIG. 1A. The peaks of the saw-tooth waveform represent the points at which the output of the Integrator 29 is greater than the Voltage Reference 80. The Trigger Pulse Generator 35 then generates the Trigger Pulses 40 illustrated in the waveform labeled PT. Note that the Pulse Width tW is selected to span more than one half-cycle but less than 2½ half-cycles. This is purposely selected to insure the ON time of SCR1 in the MFCI 100 is latched to activate the compact Tripping Solenoid 57. The next waveform of FIG. 3D is labeled as HW and HW that illustrates is the relationship between the Trigger Pulses PT and . Two HW cycles are shown in the middle portion to indicate the total phase angle during a period when the active compact Tripping Solenoid 57 is active. The bottom waveform of FIG. 3D is labeled as iBS and that illustrates the relationship between the Trigger Pulses PT and iBS, the current through the compact Tripping Solenoid 57. The waveforms show that the compact Tripping Solenoid 57 is activated for every other half-cycles while deactivated for one half-cycle. This is purposely selected to insure the ON time of SCR1 in the MFCI 100 activates the compact Tripping Solenoid 57. A second Triggering Pulse PT is generated (shown in dashed lines) if the first pulse did not result in opening the Breaker Contacts 58/59. Because the compact Tripping Solenoid 57 is activated at only the half-cycle times, the Pulse Width tW of the Triggering Pulse PT must be set wider than in the example illustrated by FIGS. 3A and 3B. Note that while for this particular embodiment a specific limit on the pulse width tW and period of the Triggering Pulse PT are specified, in actuality, the pulse width tW and the period of the Triggering Pulse PT can be set to any value.

As shown in FIGS. 3A to 3D, a method of energy control is disclosed in this invention by employing special driving circuits as that exemplified in the MFCI described above, to deliver to the compact tripping solenoid of a circuit breaker, e.g., the solenoid implemented in a GFCI device. In one of the embodiments as described above, the solenoid is a compact solenoid specifically designed for use in the GFCI. The driving energy has been controlled within a specified range in order to maximize the lifespan of the compact tripping solenoid for the circuit breaker and to insure tripping reliability of the compact solenoid. The waveforms as shown above explain that a half-rectified AC, e.g. a half-wave (HW), or a fully-rectified AC, e.g., a dual half-wave (DHW), is applied to drive the circuit to generate the driving energy to the compact tripping solenoid of a mechanical circuit breaker. An SCR is connected in series with the compact tripping solenoid and is used to control the energy delivered to the compact tripping solenoid. A trigger pulse (PT) of specific pulse width tw and period is then sent to the gate of the SCR to turn on the SCR thus energize the compact tripping solenoid.

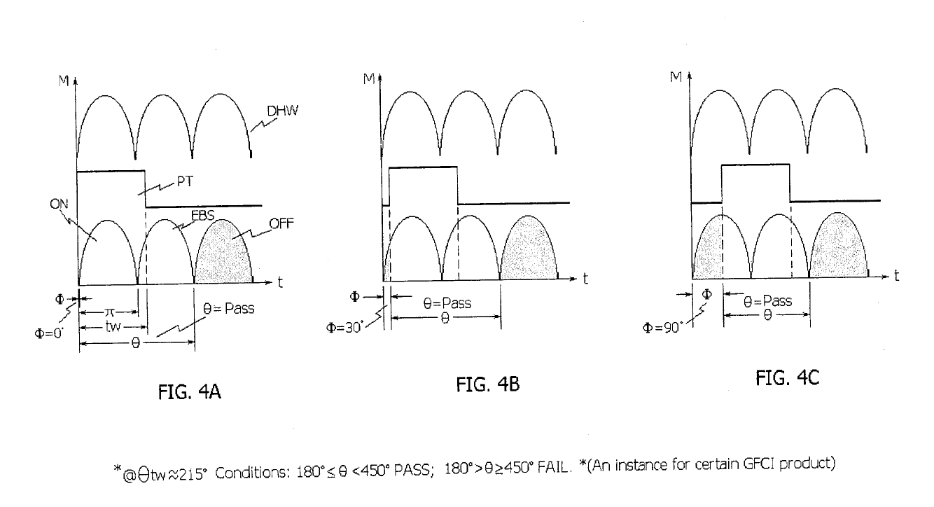

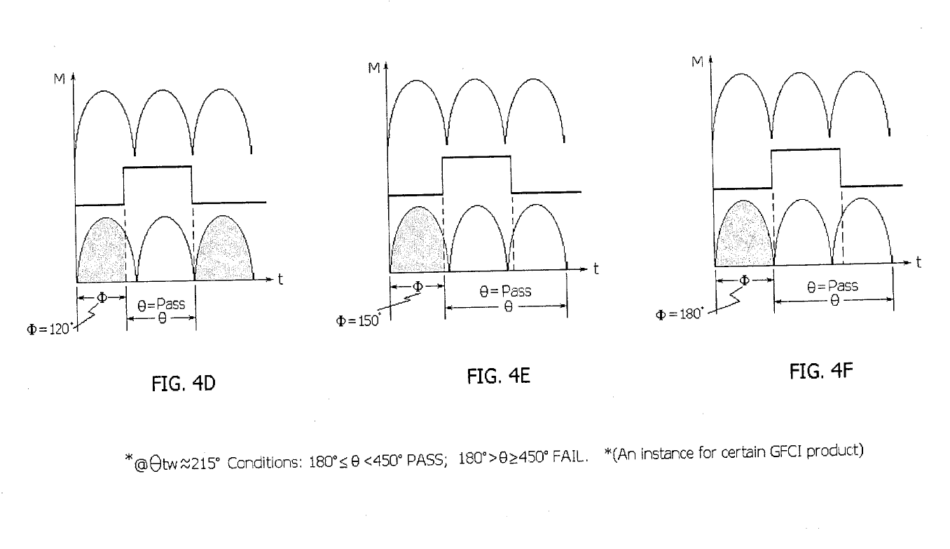

As that shown in FIGS. 3A to 3D above and will be further explained below in FIGS. 4A to 6F, the triggering pulse can trigger the SCR at any initial phase due to the fact that an over current condition can occur randomly at a random initial phase φ of an AC cycle. The MFCI is designed to accommodate any random initial phase for the purpose of delivering an amount of energy suitable for the compact tripping solenoid. Specifically, as will be further illustrated below, when the compact tripping solenoid is turned on for a period exceeding a maximum duration, damages may often occur due to over heating as too much current passes through the solenoid. On the other hand, if the solenoid is turned on for a duration less than a minimum length of time, the solenoid would not have sufficient power to trip the mechanical circuit breaker to interrupt the current flowing through the electric circuit. Therefore, regardless of the initial phase angle φ when the solenoid is turned on, the driving circuit must be designed to keep the compact tripping solenoid activated for an acceptable range of duration between the minimum and maximum length of time as required by the mechanical circuit breaker mechanism.

According to above descriptions of this invention, the MFCI takes advantage of a specific self-latching nature of the SCR that once triggered, the SCR remains-on automatically until the voltage between the anode and the cathode has a zero crossing or reversed polarity. Two variables control the amount of energy delivered to the compact tripping solenoid. The first variable is the initial phase angle φ when the tripping pulse of the SCR is triggered-on. The second variable is the pulse width of the triggering pulse tw. Since the initial phase angle φ can be a random angle between zero to three hundred and sixty degrees, a special technique is disclosed in this invention to preset the specified pulse width tw to assure the correct amount of energy is delivered to the compact tripping solenoid for all the random initial phase angles. Depending on the functional characteristics of the circuit breaker and the compact tripping solenoid, the driving circuit in the MFCI of this invention is designed to activate a triggering pulse with particular pulse width tw such that the duration for turning on the compact tripping solenoid is always maintained automatically between a maximum and minimum allowable length of time for all possible initial phase angles that can occur at any random phase angle between zero to three hundred and sixty degrees.

Particularly, FIGS. 3A to 3D illustrate that there is a functional relationship between the pulse width of the trigger pulse tw generated by the over-current protection circuit 100 of this invention and time duration tbs while the current ibs is conducted through the tripping solenoid. Specifically, the time duration tbs is a function of the pulse width tw of the trigger pulse generated by the over-current protection circuit 100. Furthermore, referring to FIGS. 3B and 3D, the duration of current conduction through the solenoid tbs is also a function of the initial phase angle φ when the triggering pulse is generated and the waveforms, e.g., the dual half-wave (DHW) or the half-wave (HW) as shown in FIGS. 3B and 3D respectively. As explained above, in order to control the energy supplied to the compact solenoid to activate a circuit tripping action, the time duration tbs must be controlled within a permissible range. However, since the triggering pulse can be randomly generated at various initial phase angle φ, a method of energy control is disclosed in this invention to achieve the goals for controlling the time duration tbs to accommodate random initial phase angle φ when the functional characteristics of the mechanical circuit breaker, e.g., the GFCI or other types of circuit breakers, are known. FIGS. 4A to 6F further explain such methods of design that determines the pulse width of the triggering pulse tw to control the total energy supplied to the compact tripping solenoid. As shown in FIGS. 4A to 6F, for the convenience of analyses, the waveforms are shown in terms of phase angles instead of length of time, to ensure the circuit designs would be applicable for AC currents that could be supplied at different frequencies, 50 Hz, 60 Hz or other frequencies. Thus the time duration tw is now shown as θtw and tbs is now represented by a working phase angle θ that represents a total accumulated “working phase-angle for solenoid current conduction” for providing an indicator of total energy supplied to the compact tripping solenoid.

FIGS. 4A to 4F shows the working angle θ of the current passing through the compact tripping solenoid when the trigger pulse is activated at different initial phase angles φ. A relationship is shown between the trigger pulse width tw with six typically specific initial phase angles φ, and the working angle θ of the current passing through the compact tripping solenoid for an embodiment of MFCI design for a typical GFCI attachment. As shown this example in FIGS. 4A to 4F, a pulse width tw is selected to ensure that the working angle θ spans over a range between one half-cycle to 2½ half-cycles. An appropriate amount of energy is delivered to the compact tripping solenoid by controlling the ON time of the solenoid within this range to activate over current tripping automatically. If the over-current condition continues to exist the MFCI generates another Triggering Pulse to the SCR.

As shown in FIGS. 4A to 4F, for an embodiment of the MFCI design for a typical GFCI attachment., the permissible range of θ is between 180° and 450° and the width angle of the triggering pulse θtw is selected and preset as 215°. For a GFCI that utilizes the dual half-wave (DHW) to drive the Tripping Solenoid, when the initial phase angle φ is 0°, 30°, 90°, 120°, 150°, and 180°, e. g, FIGS. 4A, 4B, 4C, 4D, 4F, and 4F, the total working phase angle θ, is 360°, 330°, 270°, 240°, 390°, and 360° respectively. All the working phase angles shown in FIGS. 4A to 4F fall within the range of 180° and 450°. So this triggering pulse PT when set at θtw=215° is able to generate a working phase angle θ in the permissible range to automatically control the energy provided to the compact solenoid for activating a trip action. The MFCI module can therefore initiate the trip-triggering action at random initial phase angles without over or under supplying the tripping energy to the compact tripping solenoid.

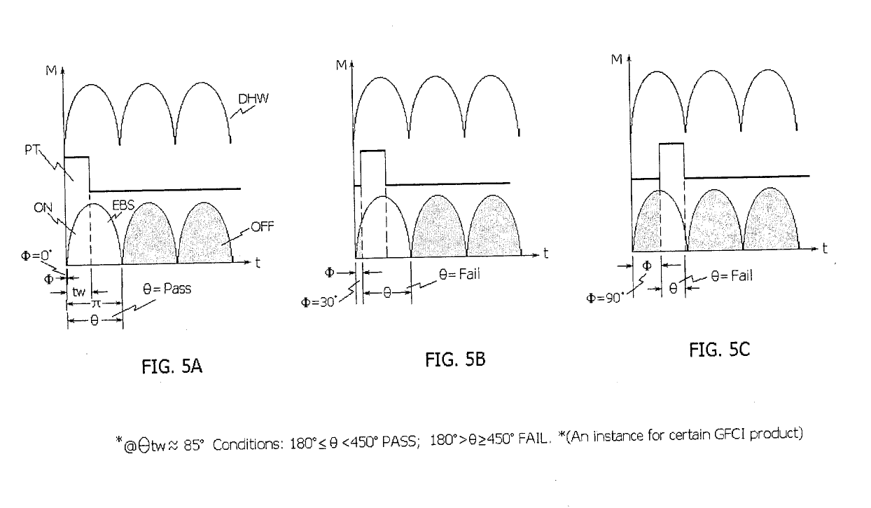

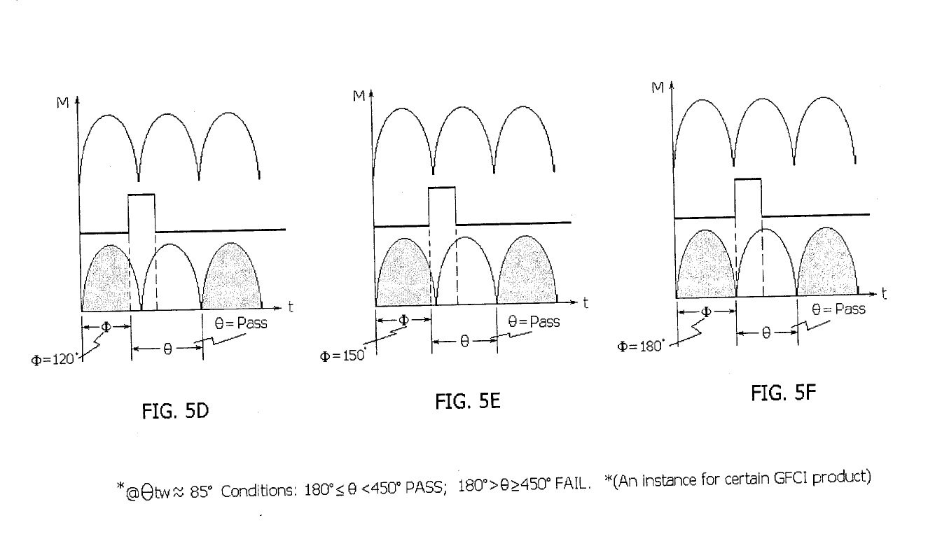

As shown in FIGS. 5A to 5F, the permissible range of θ is between 180° and 450° and the width angle of the triggering pulse θtw is selected and preset at 85°. For a GFCI that generates dual half-wave (DHW), when the initial phase angle φ is 0°, 30°, 90°, 120°, 150°, and 180°, e.g, the total working phase angle θ has been controlled and generated at 180°, 150°, 90°, 240°, 210°, and 180° respectively. All the working phase angles shown in FIGS. 5A to 5F, except that shown in FIGS. 5B and 5C, fall within the range of 180° and 450°. So this triggering pulse PT is not acceptable as it may cause the θtw to be less than 85°. The triggering pulse is too narrow and the energy to the compact tripping solenoid will be insufficient to trip the mechanical circuit breaker when the initial phase angle φ gets close to 30° or 90°. The MFCI module therefore is limited to operate with the triping action initiated only at certain range of initial phase angles and fail when the initial phase angle is outside of that range.

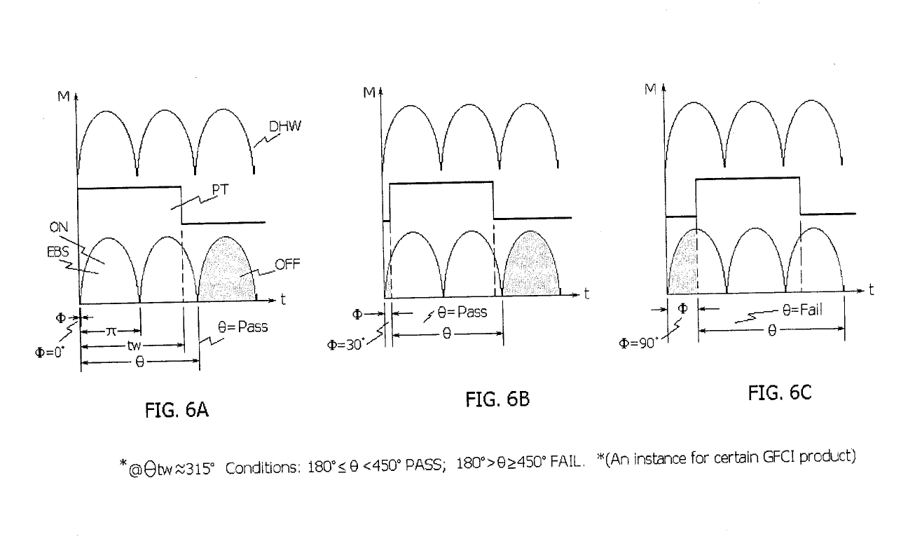

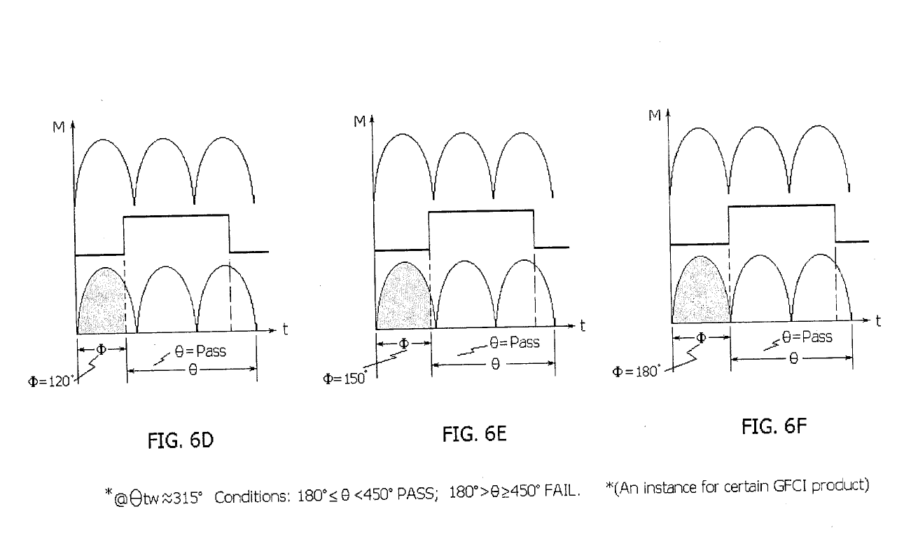

As shown in FIGS. 6A to 6F, the permissible range of θ still is between 180° and 450° and the width angle of the triggering pulse θtw is selected and preset as 315°. For a GFCI that generates dual half-wave (DHW), when the initial phase angle φ is 0°, 30°, 90°, 120°, 150°, and 180°, i. e. g, the total working phase angle θ has been controlled and generated at 360°, 330°, 450°, 420°, 390°, and 360° respectively. All the working phase angles shown in FIGS. 6A to 6F, except that shown in FIG. 6C, fall within the range of 180° and 450°. So this triggering pulse PT is also not acceptable since it causes θtw to exceed 315°, When the pulse width is too wide, the energy passed on to the compact tripping solenoid may exceed a maximum threshold and cause overheating and damage to the tripping solenoid coil as the over current initial phase angle φ gets close to 90°.

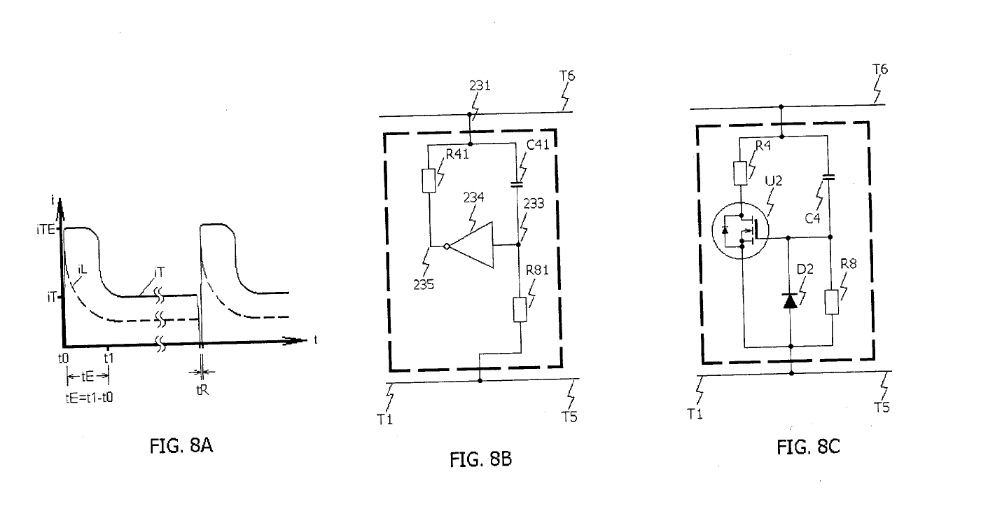

According to the 18 waveform timing analysis as above, The MFCI circuit controls the output signal to drive the compact tripping solenoid of the mechanical circuit breaker of the GFCI in a specified energy range to insure solenoid tripping reliability and safety. Unlike the traditional GFCI designs, the over current protection function carried out the MFCI of this invention does not depend on any electrical- or mechanical time delay or closed -loop response time delay as that commonly implemented in the conventional GFCI. FIGS. 8A shown together with 8B are circuit schematic diagrams showing the another embodiment of the initial tripping current dynamic expanding (ITDE) circuit of this invention for providing a multiple-stage over-current protection device.

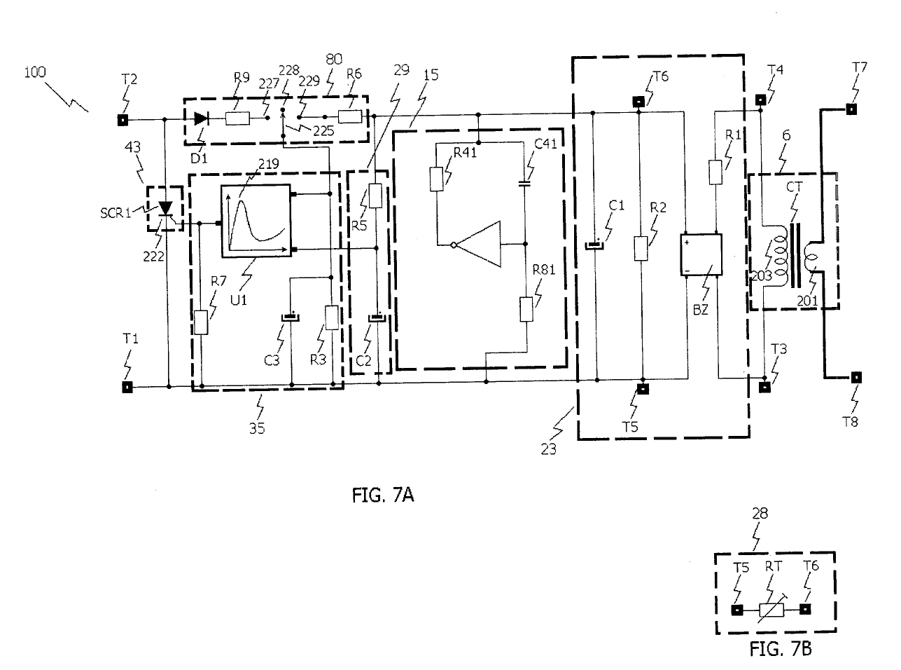

A more specific circuit implementation is disclosed in FIG. 7A and 7B. As that shown in FIG. 7A, the multi-fault circuit interrupter (MFCI) 100 includes a current transformer sensor 6 implemented with a primary and secondary coils 201 and 203 respectively for sensing and generating an AC input voltage in response to a load input current. The AC input voltage then inputting to an AC/DC converter 23 implemented with BZ, R1, R2, C1 and a tripping resistor RT connected in parallel for generating a DC voltage signal and a reference voltage. As shown in FIG. 7B, the tripping resistor RT is connected between T5 and T6 and can be adjusted for adjusting the tripping threshold for over current protection. An initial tripping current dynamic expander (IDTE) 15 is connected in parallel between the AC/DC converter 23 and a saw-tooth waveform circuit 29 implemented with R5 and C2 as shown. The details of the ITDE 15 are described with further details below. The saw-tooth waveform circuit 29 is employed with a relaxation oscillator 35 wherein the saw-tooth waveform circuit 29 is implemented with R3, C3, U1, and R7 as shown to generate a saw tooth signal on the input terminal of relaxation oscillator 35. A reference DC voltage circuit is implemented with R6, R9, and switch 225 to switch between terminals 227 228, and 229. The reference voltage connection selector 228 is provided with different options for connecting to an input voltage reference voltage through R6 which direct draw a voltage from the AC/DC converter 23. The reference voltage connector is also provided with an option for externally connecting to the SCR1 222 reference voltage through R9 for drawing a reference voltage from the SCR1. A special advantage of the present invention is the option as further described below to make use of the AC input current to provide this reference voltage thus eliminates the need for an external power supply. The transistor U1 can be implemented as a UJT (Uni-Junction Transistor) or PUT (Programmable Uni-Junction transistor) or a PNP-NPN Bi-polar transistor pair and makes use of a reference voltage of provided from a reference voltage connection selector 90. As the saw tooth shaped voltage processed by the relaxation oscillator 219, under the circumstance when an over-current occurs, a series of pulses are generated. The first pulse is imposed onto the SCR1 222 to active a tripping function to be carried out by a GFCI or other kinds of circuit interrupters connected to the MFCI 100 via terminals T1 and T2 as that shown in FIGS. 1 to 3.

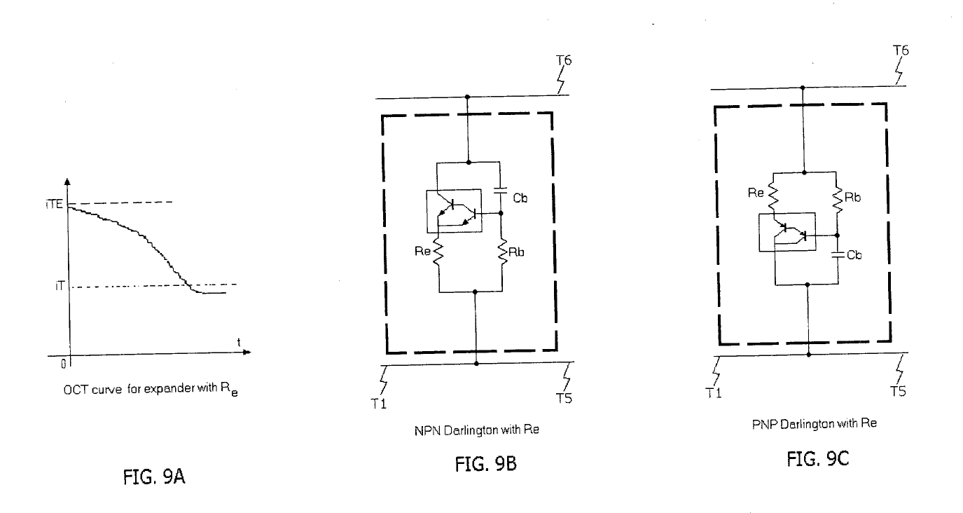

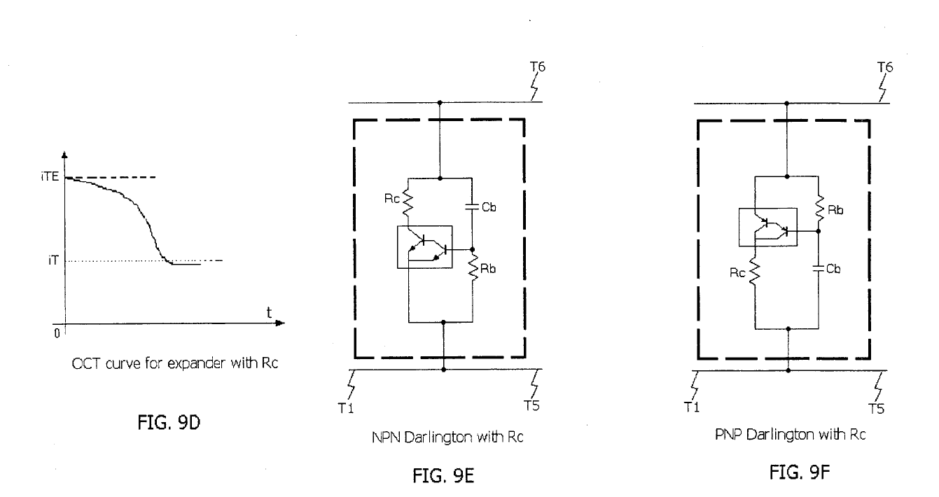

FIG. 8A illustrates a multi-stage tripping operation of the MFCI with the tripping current dynamic expander circuits as that shown in FIGS. 9B to 9C as described below. The dynamic expander circuit is implemented with the MFCI to manage the current with a time variation profile shown as a Tripping Current level iT. In this example the current profile is shown as a two-stage over-current tripping device, while multiple stages can be conveniently implemented in different preferred embodiment as that shown in FIGS. 9A to 9F below. Specifically, during the initial turn on period t0 to t1, the current detection limit for the MFCI is preset at an Expanded Tripping current level iTE that is higher than a steady normal tripping level. This expanded tripping current level permits the MFCI to ignore a condition that the initial over-surge current exceeds a normal steady-state tripping current limit iT when the electric power is first applied to a load. The time from t0 to t1 is referred to as Expanded Current setting Time tEX. This time duration represents a time delay of tEX generated by the Dynamic Expander circuit thus provide a “first stage” protection of a multi-stage current protection mechanism within the MFCI. In the first stage, during the time between the load is first turned on to the time when t=tEX, if a load current iL exceeds the setting of iTE, the MFCI is activated to generate a Trigger Pulse PT to trigger the SCR which will then activate the Tripping Solenoid thus initiates a trip event to protect the load and the power line from an first stage over-current condition. On the other hand, if the load current iL remains below the iTE limit and the time delay in the Dynamic Expander tEX expires, the MFCI goes into the Steady-State current detection mode and sets the current limit to iT. If the current exceeds the value of iT the MFCI will generate a Trip Event to activate the Tripping Solenoid as a “second stage” over current protection to protect the load and the power line.

Referring to FIG. 8B for a circuit diagram for a dynamic expander of this invention. At a power-off condition, assuming there is no charge stored in the capacitor C41. Once the power supply is turned on when a secondary voltage output of the current transformer is inputted to the ITDE circuit through a positive and negative terminals T6 and T5 respectively, with a high internal impedance, a charge to the capacitor C41 begins. The voltage V233 rapidly increases and then maintain at a high level for a specified time at junction 233, i.e., the voltage across a resistor R81 begins to decrease relative to the high voltage level at terminal T6. The inverter 234 initially receives a high level input V233 to drive V235 to the same level at terminal T5. After a specified time, V235 recovers to its nominal level. Due to the internal impedance of the power supply including R1 as that shown in FIG. 8B, the higher current flows through the resistor R41 and is shunted to ground terminal T1-T5. This causes the signal voltage V231 i.e., the voltage at terminal T6, to drop even lower thus preventing the MFCI that is connected in parallel to the ITDE to activate an over current trip event. As the time proceeds, the voltage at T6 drops to a lower level until it reaches the low threshold of the inverter 234, then the voltage of at junction 235 is reverted back to the voltage of T6, and the voltage at T6 is restored back to the normal level as that inputted from the main circuit, i.e., the MFCI. The time duration for the voltage T6 to drop to the low threshold of the inverter 234 is tE. Within this time duration, if the voltage of T6 exceeds the expanded tripping voltage corresponding to the iTE as shown in FIG. 9A, the MFCI is activated to initiate a over current trip event. With the inverter 234 functions as a switch to turn on and off between the junctions 235 and terminal T5, the ratio of the resistance of R41 to the internal impedance of the power supply, that includes RI shown in FIG. 7A,_determines the expansion ration of iTE to iT, i.e., (iTE/iT), while the product of C41 and R81, i.e., (C41)*(R81), in combination with the threshold of the inverter 234 to determines the first stage expanding duration tE.

Referring to FIGS. 8C, for a similar time sequence as that described above for the ITDE shown in FIG. 8B above. The functional characteristics of the diode D2 in combination with the internal impedance of the power supply provides a discharge impedance for the capacitor C4 and thus determines a discharge time tR. The function carried out by capacitor C4 is the same as that of C41 of FIG. 9B, and the resistor R4 and MOSFET U2 perform same functions corresponding to that of R41 and inverter 234 respectively. Referring to FIGS. 9A and 9D for two alternate functional characteristics of ITDEs implemented by two sets of similar embodiments illustrated in FIGS. 9B, 9C and 9E and 9F represented. The functional characteristics of these two alternated ITDEs illustrated in FIGS. 9A and 9E as current (I) versus time (t) similar to that shown in FIG. 8A except that a more gradual decrease of current over time. The basic functions as that implemented in FIGS. 10B, 10C and 10E, 10F and carried out by different electrical components are similar to that described for FIG. 8B. Specifically, in FIGS. 9B and 9C, the functions performed by resistors Re, Rb and capacitor Cb corresponding to that of resistors R41, R81 and capacitor C41 respectively. And, in FIGS. 9E and 9F, the functions performed by resistors Rc, Rb and capacitor Cb correspond to that of resistors R41, R81 and capacitor C41 respectively. The NPN or PNP Darington transistors as illustrated in FIGS. 9B, 9C, 9E and 9F, carry out functions similar to that described for the MOSFET U2 as explained above for FIG. 8C.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A method for providing to a trip-driving circuit an amount of energy accumulated over a controlled-accumulation duration of said trip-driving circuit comprising:
generating a triggering voltage-pulse with a controlled pulse width across a thyristor for imposing said triggering voltage-pulse and actuating said trip-driving circuit over said controlled-accumulation of said trip-driving circuit.

2. The method of claim 1 wherein:
said controlled-accumulation duration covering a length of time corresponding to at least a half-wave duration generated by said trip-driving circuit for responding to said triggering voltage-pulse for actuating said trip-driving circuit to deliver said amount of energy accumulated over said controlled-accumulation duration for executing a circuit trip action.

3. The method of claim 1 further comprising:
providing a means for adjusting an actuating condition for generating said triggering voltage-pulse for dynamically expanding a tripping range of said trip-driving circuit.

4. The method of claim 1 further comprising:
providing a multi-stage tripping-range adjusting means for generating a multi-stage actuating threshold including an initial surge threshold and at least another threshold for generating said triggering voltage-pulse to actuate said trip-driving circuit.

5. The method of claim 1 wherein:
said step of imposing said triggering voltage-pulse and actuating said trip-driving circuit further includes a step of imposing said triggering voltage-pulse over a thyristor implemented as a Silicon Controlled Rectifier (SCR) to actuate a solenoid of a mechanical circuit breaker mechanism over said controlled-accumulation duration of said trip-driving circuit of said solenoid.

6. A circuit fault protection device for responding to a circuit fault to actuate an energy accumulation for a trip-driving circuit over a controlled-accumulation duration, said circuit fault protection device comprising:
a triggering voltage-pulse generator for generating a triggering voltage-pulse of controlled width across a thyristor for imposing said triggering voltage-pulse in said controlled-accumulation duration over said trip-driving circuit to actuate a fault protection trip.

7. The circuit fault protection device of claim 6 wherein:
said trip-driving circuit generating a voltage of plurality of half-waves and said triggering voltage-pulse generator generating said triggering voltage-pulse of said control pulse width over a controlled-accumulation duration covering at least one of said half-waves.

8. The circuit fault protection device of claim 6 further comprising:
a means for adjusting an actuating condition for generating said triggering voltage-pulse for dynamically expanding a tripping current range of said trip-driving circuit.

9. The circuit fault protection device of claim 6 further comprising:
a multi-stage tripping current range adjusting means for generating a multi-stage actuating threshold including an initial surge threshold and at least a second threshold for generating said triggering voltage-pulse to actuate said trip-driving circuit.

10. The circuit fault protection device of claim 6 further comprising:
an adopting means for adopting said circuit fault protection device to a ground fault circuit interrupter (GFCI) for imposing said triggering voltage-pulse over said thyristor implemented as a Silicon Controlled Rectifier (SCR) to actuate a trip-driving circuit over said controlled-accumulation duration for actuating a solenoid in said GFCI.

11. A method for protecting an electric device from a circuit fault comprising: (make this claim more general)
controlling a circuit breaker current i_{BS} and a length of a current-conducting duration t_{BS} for conducting said circuit breaker current through a tripping-solenoid of a mechanical circuit breaker mechanism triggered by said circuit fault for providing controlled amount of energy to said tripping-solenoid to trip said mechanical circuit breaker mechanism and interrupt a current conducting through said electric device.

12. A fault protection apparatus for protecting an electric device from a circuit fault comprising:
a ground terminal connected to a common ground terminal with a ground fault circuit interrupter (GFCI);
a trigger-pulse terminal connected to a solenoid tripping control terminal of the GFCI for responding to said circuit fault to provide a trigger-pulse with a controlled pulse with a pulse width t_{w} for conducting a corresponding circuit breaker current i_{BS} during a duration t_{BS} corresponding to the pulse width t_{w} through a solenoid of said GFCI for providing controlled amount of energy to said solenoid to trip said GFCI and interrupt a current conducting through said electric device

13. A multi-stage over-current protection device for activating a circuit interruption upon detecting a current exceeding a stage-wise current threshold in each of a plurality of stages comprising:
an independent time duration setting means for setting a duration for each of said stages in applying each of said stage-wise current thresholds to protect a circuit.

14. An over-current protection device comprising:
an over current protection adapting means adapting to a current interrupter through a pair of adapting terminals wherein said over current protecting adapting means further includes a current transformer for transforming a load current to a corresponding voltage for detecting an above-threshold voltage to generate a current-interruption voltage signal for inputting to said current interrupter through said pair of adapting terminals for interrupting said load current.

15. The hybrid over-current protection device of claim 14 wherein:
said over current protection adapting means receiving power only from said current transformer to detect said above-threshold voltage to generate said current interruption voltage signal for inputting to said current interrupter.

16. The over-current protection device of claim 14 wherein:
said over current protection adapting means consumes no power when no current flows through said current transformer as a load connected to said over current protection adapting means is disconnected.

17. A method for controlling a working phase angle represented by θ for conducting a rectified current of a periodic waveform cycling between a phase angle between 0° and 360° through a trip-driving circuit, the method comprising:
generating and imposing a triggering voltage-pulse initiated at an initial phase angle represented by φ with a controlled pulse-width represented by θtw across a thyristor with a self-latch conducting characteristic for continuously conducting said rectified current through said trip driving circuit for a controlled duration represented by said working phase θ wherein said working phase θ is within a preset range for all initial phase angle represented by φ between 0° and 360°.

18. The method of claim 17 further comprising a step of:
controlling said pulse width θtw to generate a phase angle θ within a permissible range between a maximum and minimum current conduction duration represented respectively by θmax and θmin for all the initial phase angle φ between 0° and 360°.
